(19) United States
(12) Patent Application Publication
(10) Pub. No.: US 2026/0138670 A1
(43) Pub. Date: May 21, 2026

(54) Steering Damper Assembly

(71) Applicant: N10Z Performance Shocks LLC, Johnson City, TN (US)

(72) Inventor: Peter Russell, Johnson City, TN (US)

(73) Assignee: N10Z Performance Shocks LLC, Johnson City, TN (US)

(21) Appl. No.: 19/393,554

(22) Filed: Nov. 18, 2025

Related U.S. Application Data
(60) Provisional application No. 63/722,075, filed on Nov. 19, 2024.

(51) Int. Cl. B62D 7/22

(52) U.S. Cl. CPC B62D 7/226

(57) ABSTRACT

A steering damper assembly is provided having a chassis damper stay, a steering rack, and a damper. The chassis damper stay is configured to mate at a first end with a first vehicle chassis frame member and at a second end with a second vehicle chassis frame member spaced apart from the first member. The steering rack and pinion assembly is provided intermediate the first end and the second end and carried by the chassis damper. The damper carried for movement at a first end by the steering rack on the rack and pinion assembly and acting against the chassis damper stay at a second end to dampen movement of the rack, the damper having a preloaded spring resisting extension and retraction of the damper.

### CROSS REFERENCE TO RELATED APPLICATIONS

This patent application claims the benefit of U.S. Provisional Patent Application Ser. No. 63/722,075, filed Nov. 19, 2024, entitled “Steering Damper Assembly”, the disclosures of which are incorporated herein by reference.

### TECHNICAL FIELD

The technical field relates to vehicle steering assemblies, and more particularly to damping and strengthening systems for steering systems including rack and pinion steering systems used particularly in harsh off-road and race environments.

### BACKGROUND OF THE DISCLOSURE

Enforced tie rod and rack connecting brackets, or steering flags are known for use on off-road recreational and racing vehicles, such as UHV or side-by-side vehicles navigating rugged courses having uneven and/or boulder strewn obstacles on course. There exists a need to further strengthen and stabilize steering components on such vehicles, both for systems that use manual rack and gear steering, as well as power steering. Such improvements are also needed on any vehicle having a steering system and suspension including autonomous and/or user driven vehicles.

Steering dampers have been around for ages and as vehicles change so do location to mount the damper. In most recent vehicles, the rack location and mounting location is in need of escalating the mount stiffness and tighter tolerances wherein a damper can be added to control steering with high deflection. There exists a need to increase damper control and response time and maintain rigidity that is needed to have a highest level of damper stiffness and the highest level of mounting rigidity.

### SUMMARY OF THE INVENTION

A steering damper assembly are provided for stabilizing and mitigating forces and shock transmissions through a steering system of a vehicle. Structural stiffness of the steering damping system is improved to improve vehicle handling. Preloaded springs in the shock/damper improve response time and feel by having a fully loaded interconnect between a drive control and a vehicle wheel. Finally, a remote adjustment of shock/damper flow characteristics enables remote adjustment while on the fly, such as while driving or racing a vehicle.

According to one aspect, a steering damper assembly is provided having a chassis damper stay, a steering rack, and a damper. The chassis damper stay is configured to mate at a first end with a first vehicle chassis frame member and at a second end with a second vehicle chassis frame member spaced apart from the first member. The steering rack and pinion assembly is provided intermediate the first end and the second end and carried by the chassis damper. The damper carried for movement at a first end by the steering rack on the rack and pinion assembly and acting against the chassis damper stay at a second end to dampen movement of the rack, the damper having a preloaded spring resisting extension and retraction of the damper.

### BRIEF DESCRIPTION OF THE DRAWINGS

FIG. 1 is a front perspective passenger side view of a vehicle steering system damper mounting assembly.

FIG. 2 is a front perspective driver side view of a vehicle steering system damper mounting assembly.

FIG. 3 is a rear perspective driver side view of a vehicle steering system damper mounting assembly taken from a driver side view behind an A-pillar.

FIG. 4 is a front perspective view of a chassis damper bracket corresponding with a view shown in FIG. 1.

FIG. 5 is a front perspective passenger side view of a steering rod/rack/shock mounting assembly corresponding substantially with a view shown in FIG. 1.

FIG. 6 is a perspective front view of a chassis damper bracket.

FIG. 7 is a front perspective driver side view of a steering rod/rack/shock mounting assembly shown in FIG. 5.

FIG. 8 is front perspective passenger side view of a vehicle steering system damper mounting assembly having a unitary damping stay integrally welded to a vehicle frame.

FIG. 9 is a further forward front perspective view of the vehicle steering damper mounting assembly of FIG. 8.

FIG. 10 is a rear perspective driver side view of the vehicle steering system damper mount assembly of FIGS. 8-9.

FIG. 11 is a perspective view from below of a damper/shock mounting bracket.

FIG. 12 is a perspective view from above of a tie-rod/damper/shock mounting bracket of FIG. 12.

FIG. 13 is a centerline sectional view of the damper showing internal and spring preload details.

FIG. 14 is an exploded perspective view of stack of springs and a preload washer plate.

FIG. 15 is a simplified schematic perspective view of an assembled together assembly of the stack of washer springs and preload washer plate of FIG. 14 showing a preload bending of the stack of springs in assembly.

FIG. 16 is a remote damper/shock adjustment mechanism usable on the dampened steering wheel system of FIGS. 1-3 8-10 and 13 to remotely adjust dampening and shock characteristics.

FIG. 17 is an enlarged centerline sectional view of remote control adjustment connection of FIG. 16 on a damper rebound eyelet.

FIG. 18 is a simplified schematic diagram of an alternative electrical remote control adjustment mechanism over that shown in FIGS. 16-17.

### DETAILED DESCRIPTION OF THE EMBODIMENTS

1This disclosure is submitted in furtherance of the constitutional purposes of the U.S. Patent Laws “to promote the progress of science and useful arts” (Article 1, Section 8).

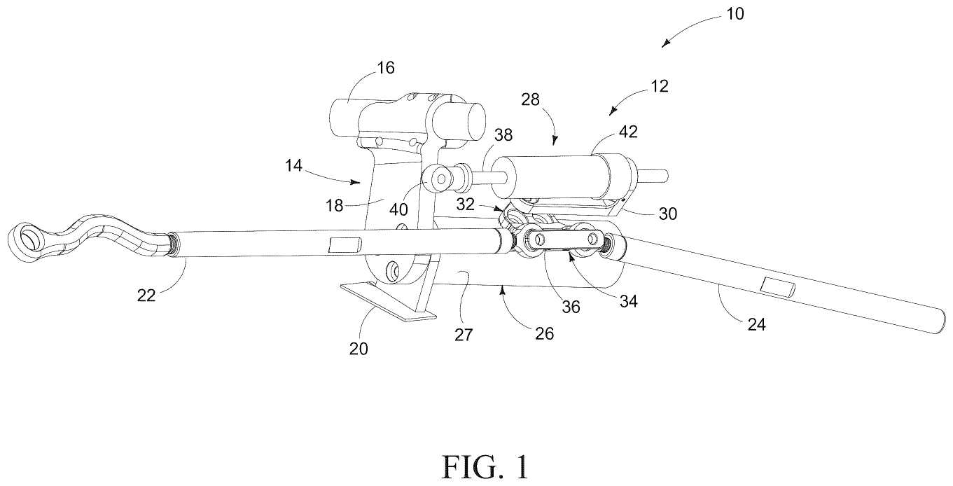

FIG. 1 illustrates a dampened steering wheel system 10 according to one aspect. A steering damper assembly 12 is provided affixed between a bolt-on vehicle frame bracket (damping stay) 14 and a tie rod connecting yoke 34 wherein bracket 14 affixes between a pair of spaced-apart structural members of a vehicle chassis to provide a rigid end mount for a piston damper rod under harsh offroad and race conditions. One member is a frame tube 16 affixed with a clamp and fasteners onto a bottom tube clamp bracket 18, while another member (not shown) is welded to a weld bracket 20 of bracket 14 which is spaced apart from tube 16. Tie rod connecting yoke 34 is integrally formed on a tie-rod/damper/steering, or flag bracket 32 that is driven in reciprocation by a linear rack assembly 26. A pair of tie rods 22 and 24 affix at each inboard end onto individual yoke mounts on one of two opposed connecting yoke members, or frames 36 of tie rod connecting yoke 34 of flag bracket 32.

As shown in FIG. 1, frame bracket, or damping stay 14 includes a bolt-on tube clamp bracket 18 affixed with three threaded fasteners to a lower weld bracket 20. A damper rebound eyelet 40 is pivotally affixed onto a leading edge of clamp bracket 18 with a studded threaded fastener having a pivotal cylindrical outer surface about which eyelet is pivotally affixed. Eyelet 40 is affixed onto one end of piston shock/damper shaft 38 that extends and retracts relative to shock/damper tube 42. Shaft 38 extends and retracts relative to a mounting bracket 30 on which shock/damper 28 is affixed to provided damping during extension and retraction of shaft 38 in both directions to dampen steering via bracket 32. Linear rack assembly 26 includes a tube 27 that has a bellows at each end (not shown) and flag bracket 32 is rigidly affixed onto an internal rack and tube 27 for driven reciprocation parallel to an axis of tube 27 in response to a driver turning a steering wheel (not shown) that reciprocates tube 27 and flag bracket 32 to move tie rods 22 and 24 to and fro (left and right) which steers wheels attached thereto (not shown). Brackets 16 and 20 of damping stay 14 are spaced apart in order to span between rigid vehicle structures that impart rigid fixation including torsional and bending stiffness while eyelet 40 and rack assembly 26 are affixed onto stay 14 at medial locations between the opposed end mounting positions (tube 16 and a frame member onto which weld bracket 20 is affixed) on the vehicle frame. In this configuration, it is observed that forces from shock/damper 28 and rack assembly 26 are applied mid-span along stay 14 while stay 14 is retained at opposed ends of the vehicle frame. As a result, any flexing or movement caused by extreme loads is minimized and vehicle handling (steering) is improved especially under extreme offroad racing conditions.

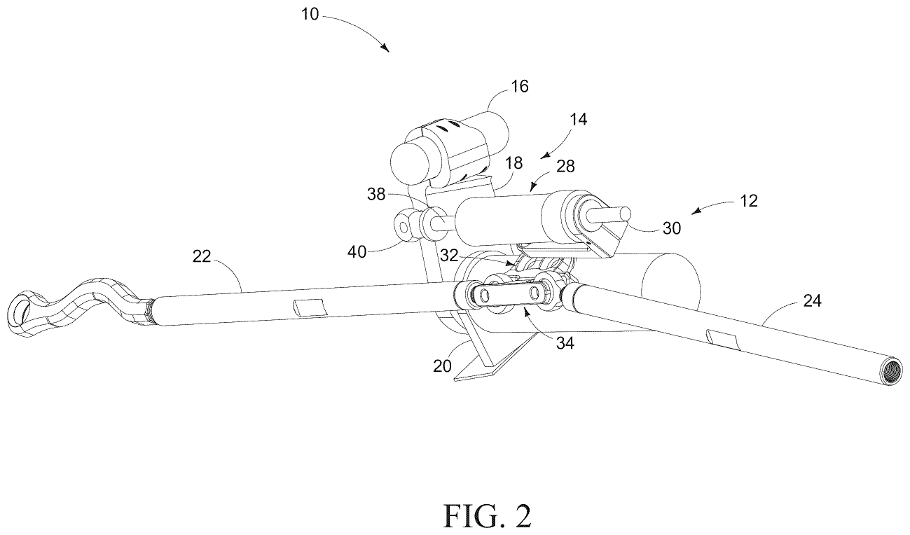

FIG. 2 is a front perspective driver side view of the vehicle steering system damper mounting assembly 10 of FIG. 1 but showing more clearly damper/shock mounting bracket 30 which is L-shaped and holds shock/damper 28 at an opposite end of damper 28 from eyelet 40. Shaft 38 extends beyond both ends of damper 28 so that there is no change in fluid volume within shock/damper 28 as shaft 38 strokes to and fro. Tie-rod/damper/steering mounting bracket 32 couples together tie rods 22 and 24 via tie rod connector bracket 34 in assembly for reciprocation to and fro. Frame bracket 14 supports steering damper assembly 12 between spaced apart structural members including frame tube 16 attached to bracket 18 and another frame member (not shown) welded onto weld bracket 20.

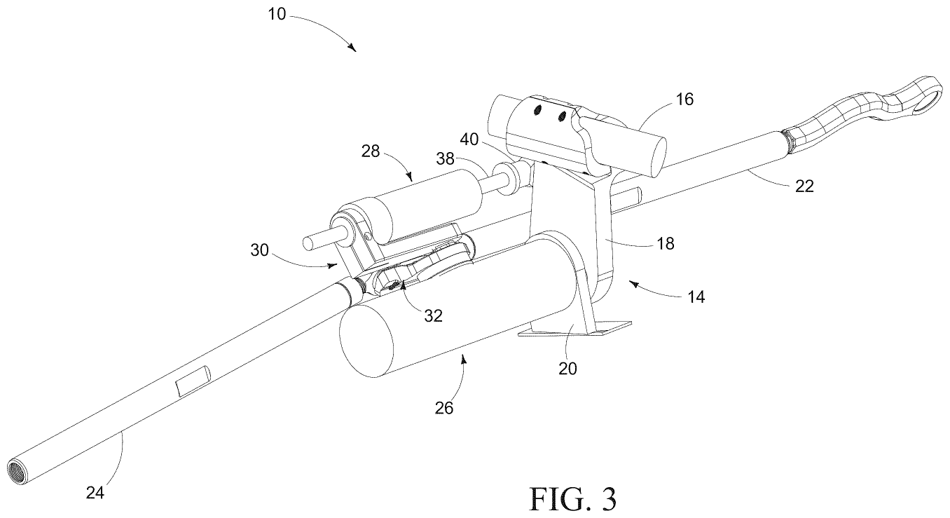

FIG. 3 is a rear perspective driver side view of vehicle steering system damper mounting assembly 10 taken from a driver side view behind an A-pillar of a vehicle. More particularly, tie-rod/damper/steering bracket 32 is affixed to a reciprocating rack of rack assembly 26. Tie rods 22 and 24 are also affixed to bracket 32 along with damper 28 and L-bracket 30. An opposed end of piston rod 36 is affixed via eyelet 40 onto bracket 18 of frame bracket assembly 14. Linear rack assembly 26 is affixed onto weld bracket 20 which is further welded onto a vehicle frame member (not shown) spaced from tubular vehicle frame member 16.

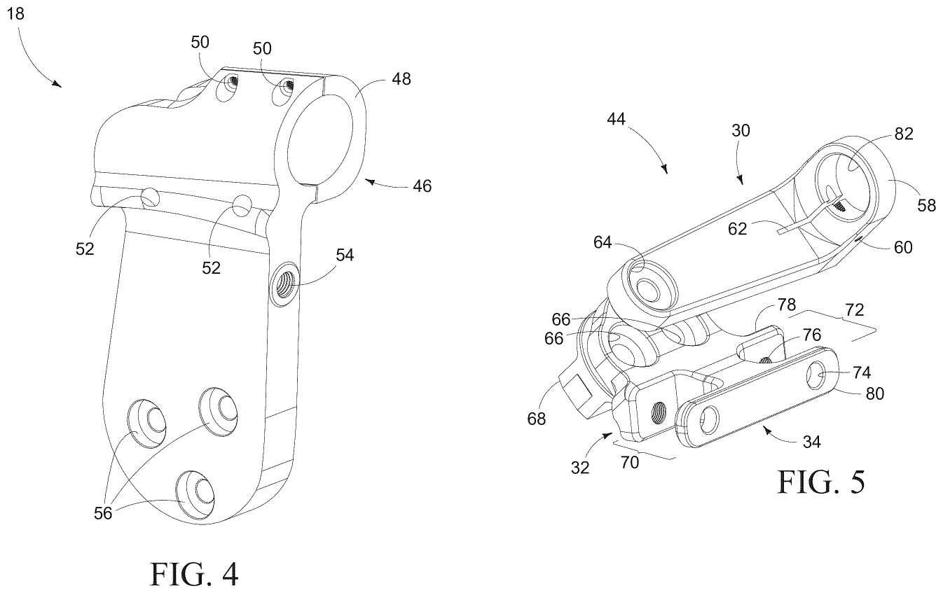

FIG. 4 is a front perspective view chassis damper bracket 18 corresponding with a view shown in FIG. 1. More particularly, a semi-cylindrical clamp member 48 is affixed to an opposing arcuate portion of bracket 18 to for a cylindrical tube clamp 46 using four threaded cap screws (not shown) receive in opposing direction through recessed and threaded bores 50 and 52. A recessed threaded bore 54 is configured to receive a headed fastener having a cylindrical surface for rotatably carrying eyelet 40 (see FIG. 1). Three recessed bores 56 are configured to receive threaded cap screws (not shown) for securing bracket 18 onto threaded bores into bracket 20 (see FIG. 1).

FIG. 5 is a front perspective passenger side view of a steering tie-rod/damper/steering mounting assembly 44 corresponding substantially with a view shown in FIG. 1. Assembly 44 includes tie-rod/damper/steering mounting bracket 32 and L-shaped damper mounting bracket 30. Bracket 30 includes a stepped recessed fastener bore 64 configured to receive a hex head cap screw (not shown) that threads into a complementary threaded bore (not shown) in bracket 32. A cylindrical hoop clamp 58 includes a cylindrical bore 82 and a compressible slot 62. A combination smooth and tapered bore that transitions at slot 62 is configured to receive a threaded fastener (not shown) that compresses hoop clamp 58 about a cylindrical outer tube surface of a damper end to retain such damper therein as hoop 58 shrinks as slot 52 compresses in response to tightening of such fastener. A pair of cap screw recessed bores 66 extend through bracket 32 along a rack base block 68 configured to receive complementary cap screws (not shown) to mount bracket 32 onto a linear rack of a rack and pinion steering device. In addition, yoke 34 includes a pair of yoke frames, forming yokes 70 and 72 configured to receive end so respective tie rods in assembly (not shown). Yokes 70 and 72 form between fingers, such as yoke 72 formed between fingers 78 and 80 with a fastener clearance hole 80 in finger 80 and a fastener complementary threaded bore 76 in finger 78.

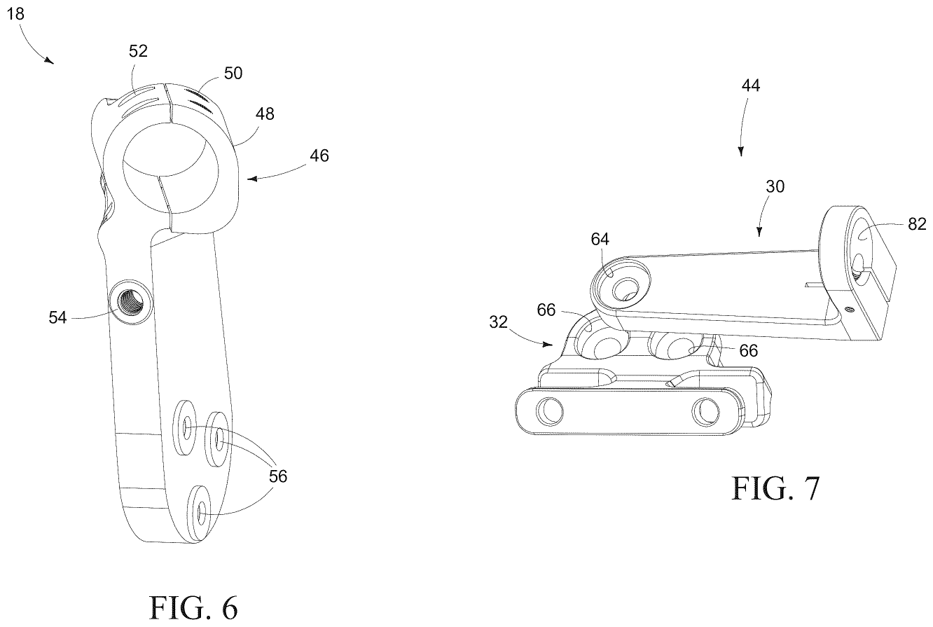

FIG. 6 is a perspective front view of a chassis damper clamp bracket 18. Compound cap screw clearance bores 52 are provided on bracket 18 and corresponding threaded bores 50 are provided on clamp 48. On a lower portion of tube clamp 46 such bores 50 and 52 are reversed in an opposed direction. Threaded damper mount 54 is shown above three bores 56 which extend into raised bosses that are received in complementary round recesses (not shown) in a complementary face of weld bracket 20 (see FIG. 3) which lock together such parts in assembly and prevent any rotation.

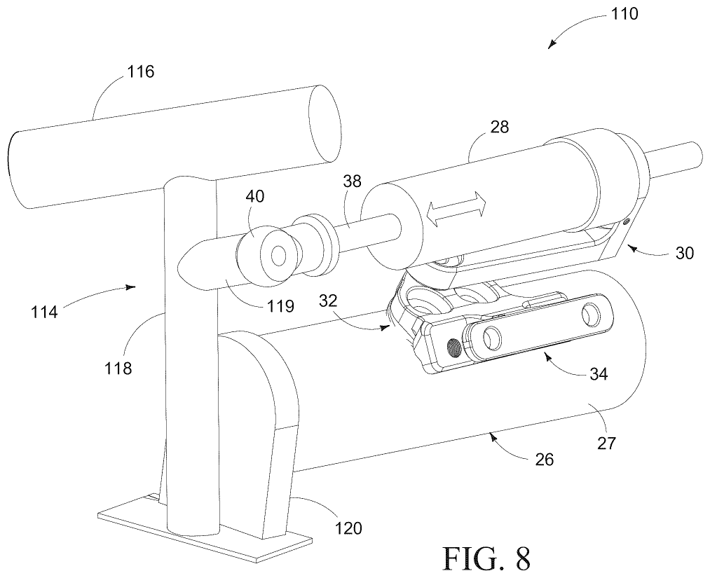

FIG. 7 is a front perspective driver side view of a steering tie-rod/damper/steering mounting assembly 44. L-shaped damper bracket 30 is shown in an assembled position (without threaded fasteners present to show parts details). A threaded fastener is inserted into recessed compound bore 62 into bracket 32 and additional threaded fasteners are received into recessed compound bore 66 to mount assembly 44 onto a rack of a rack and pinion steering assembly 26 (see FIG. 3). A damper (not shown) is securely retained in clamp ring surface 82 at one end of a shock/damper tube where there exists greater hoop strength for engagement with clamp ring surface 82. The piston rod exits from an end opposite the L-bracket compressive mount to mount to the damping stay. Shock/damper 28 (see FIG. 8) has a tubular body that ends integrally with a reduced diameter cylindrical portion having a cylindrical outer surface with a circumferential groove that is received in bore 82 and a threaded shoulder bolt (not shown) passes along the groove to trap the tubular body on L-bracket 30. Optionally, an end cup having such a reduced diameter portion can be threaded or press-fit/welded onto a shock/damper tubular body.

FIG. 8 is front perspective passenger side view of an alternative vehicle steering system damper mounting assembly 110 having a unitary damping stay, or frame member 114 integrally welded to a vehicle frame at an upper frame tube 116 and a spaced-apart lower frame member (not shown) on weld bracket 120. Frame member 114 includes a primary tube 118 and an integrally welded secondary tube 119 onto which eyelet 40 on piston rod 38 is pivotally affixed. Shock/damper 28 is affixed onto L-bracket 30 and bracket, or flag 32. Tie rod connector bracket 34 is affixed for reciprocation by affixed bracket 32 with a pair of threaded fasteners (not shown) onto tube 27 and an internal linear rack of rack and pinion steering assembly 26.

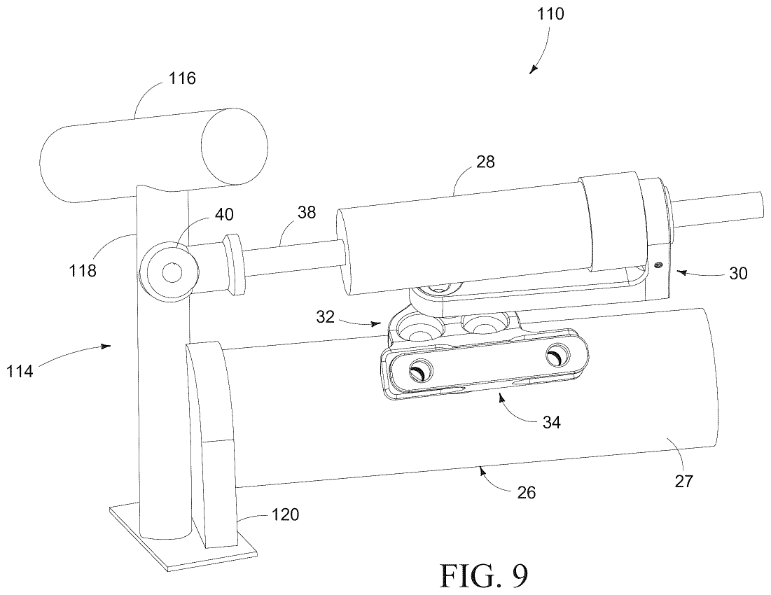

FIG. 9 is a further forward front perspective view of the vehicle steering damper mounting assembly 110 of FIG. 8. More particularly, frame member 114 comprises vertical tube 118 which extends between spaced apart vehicle frame components 116 and a lower vehicle frame member (not shown) welded to a bottom surface of weld bracket 120. Rack and pinion steering assembly is shown in a simplified view as a tube 27, but in actually construction tube 27 moves axially back and forth and has a bellows at each end (not shown). Flag bracket 32. is affixed with a pair of threaded cap screws to an internal rack in assembly 26 that reciprocates with tube 27 axially to and fro. Tie rod connector bracket 34 drives a pair of affixed tie rods to and fro to direct steering impulses to a pair of wheels (not shown). Movement of bracket 30 and damper 28 causes an internal piston to work fluid and extend and retract piston rod 38 and eye 40.

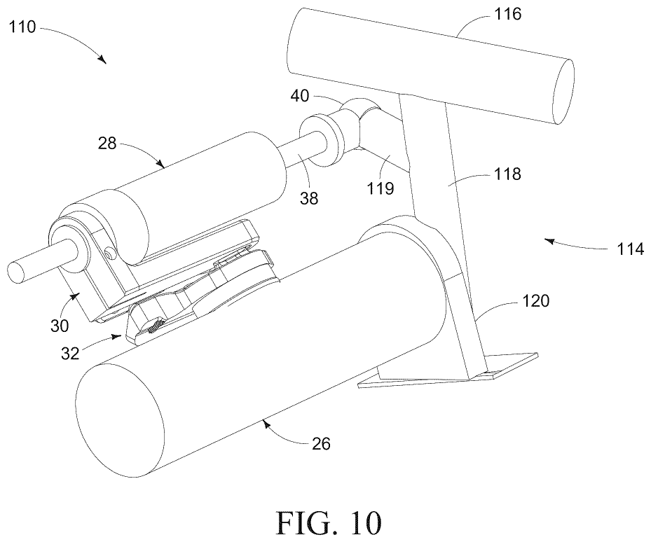

FIG. 10 is a rear perspective driver side view of the vehicle steering system damper mount assembly 110 of FIGS. 8-9. Frame tube 118 is shown integrally welded between cross member 116 and weld plate 120 while integrally welded frame member 119 extends at a medial location outwardly from frame member 118. Eyelet 40 on piston shaft 38 is rigidly affixed for rotation with a threaded fastener onto an outer end of frame member 119. Movement of a linear rack inside of rack and pinion steering assembly 26 causes flag bracket 32 to move with L-bracket 30 and damper 28 which causes a piston within damper 28 and shaft 38 to reciprocate as fluid moves through internal valves inside of damper 28.

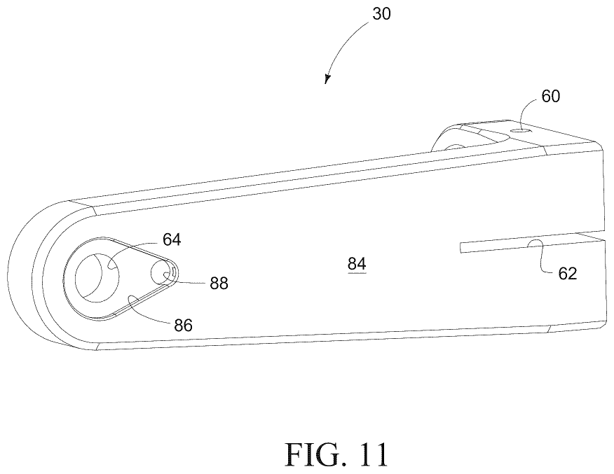

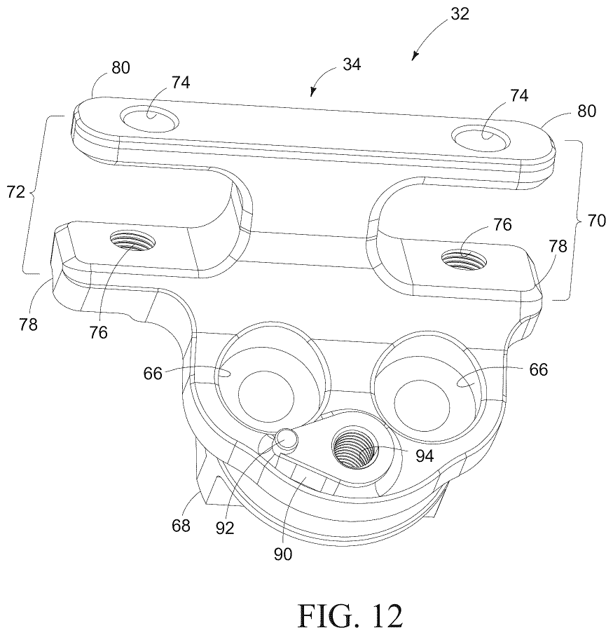

FIG. 11 is a perspective view from below of the damper/shock mounting bracket 30 showing attachment details for affixing bracket 30 onto flag bracket 32 (see FIG. 10). More particularly, bracket 30 includes an elongate body, or leg 84 that extends parallel to a longitudinal axis for a shock/damper that is mounted onto bracket 30. A compressible slot 62 is shown at one end of bracket 30 that facilitates affixation of a shock/damper onto bracket 30. A threaded fastener (not shown) is received in threaded engagement into a threaded bore 60 after passing through a clearance bore on an opposed side of slot 62 than threaded bore 60. Tightening of such fasteners closes slot 62 and clamps a shock/damper body onto bracket 30. A compound interlocking aperture array comprising a through bore 64 contiguous with a teardrop shaped recess cavity 86 and a deeper recess cylindrical bore 88 are configured to mate with a complementary male structure on flag bracket 32 (see FIG. 12) to provide translatory and rotary fixation therebetween when a cap head threaded fastener (not shown) is passed through bore 64 and into threaded bore 94 (see FIG. 12).

FIG. 12 is a perspective view from above of tie-rod/damper/steering mounting bracket 32. More particularly, Tie-rod/damper/steering mounting bracket 32 includes tie rod connector bracket 34 providing yokes 70 and 72. Yokes 70 and 72 are each formed between spaced apart legs 78 and 80. A clearance bore 74 is sized to receive a should bolt that taps into threaded bore 76 while an end eye of a tie rod is positioned therebetween. Recesses compound bores 66 are configured to receive a hex head threaded fastener to mount bracket 32 onto a rack of a rack and pinion steering assembly along rack base block 68. Raised structures on flag bracket 32 interlock and tighten within complementary female structures provided on damper bracket 30 (of FIG. 11). More particularly, female structures on bracket 32 include male teardrop boss 90 and further raised cylindrical boss 92. Threaded bore 94 is provided centrally of boss 90. Boss 90 has a slight outer peripheral taper that engages in tightening relation within complementary cavity 86 and bore 88 (see FIG. 11).

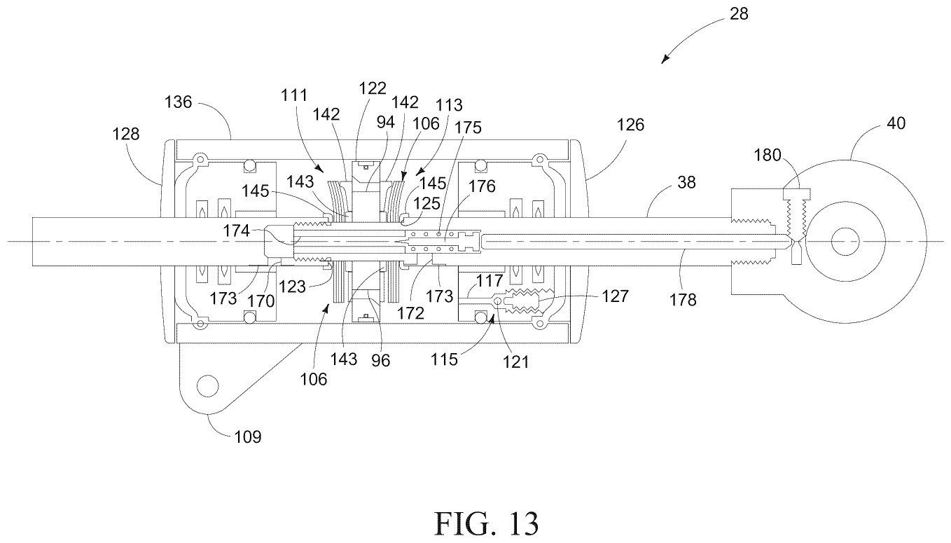

FIG. 13 is a centerline sectional view of the damper 28 showing internal and spring preload details. More particularly, a piston 122 is affixed onto assembled piston rod 38 and eyelet 40. Fluid flow is controlled passing in both directions through an array of fluid ports 94 and 96, around a preload washer plate 142 (as it axially moves) inside of piston/damper cylinder 136 and between end caps 126 and 128, and against a preloaded stack 106 of individual shims, or cylindrical springs. In assembly, cylindrical spacers, or washers 143 and 145, stacks 106 are compressed together and tightly stacked between cylindrical step down shelve, or ridges 123 and 125 on shaft 38. In this position, shims are flexed into a partially bent position, similar to that shown in FIG. 15, but to a lesser extent. As fluid enters ports 94 and 94 while piston 122 reciprocates between fluid chambers 111 and 113, a respective preload washer plate 142 slides axially along shaft 38 to further bend stack 106 to open/increase fluid flow between stack 106 and plate 142 by forming a gap between a respective piston port 94 or 96 (depending on fluid direction flow and stroke). An optional bracket 109 is welded onto tube 136 to facilitate an alternative method of attaching shock/damper 28 to a vehicle structure such as a frame member or a flag bracket.

FIG. 13 also details another fluid flow path between chambers 111 and 113 provided as piston 122 strokes within cylinder 136 resulting from load inputs from eyelet 40 (and a vehicle wheel and suspension). More particularly, an array of individual ports 172 and 173, each formed in a flat in shaft 36 connect via a fluid port 173 in shaft 36 to move fluid back and forth at an adjustable rate. Needle valve 176 biased by a spring 175 allows adjustment of the flow rate via this flow path. A beveled end extension pin 178 moves left and right based on adjustment of a bevel ended adjustment screw 180. A bleed port 117 is also provided behind end cap 126 having a sealing ball plug assembly with a ball 121 and a threaded needle set screw 127 used to open and close flow via port 117 when bleeding or adding fluid into chamber 113 and shock/damper 28.

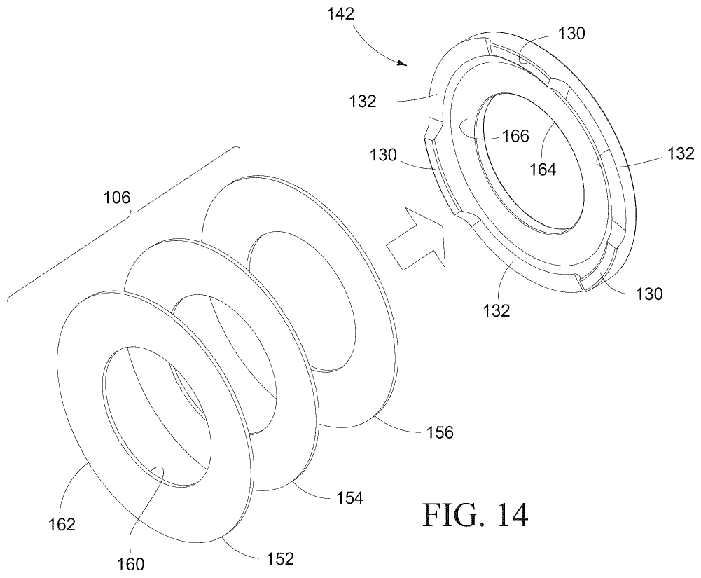

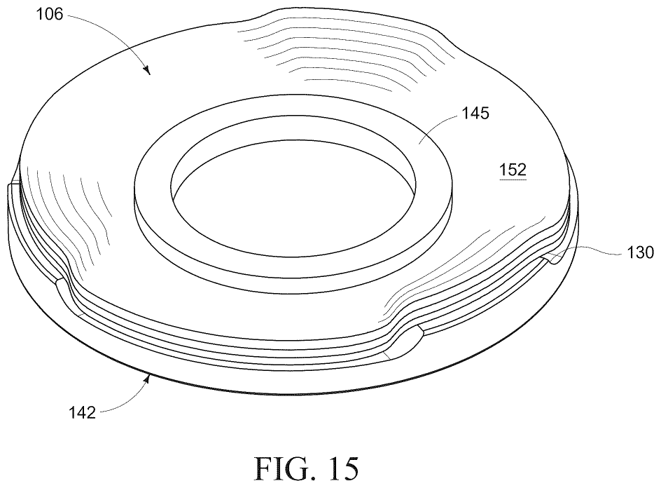

FIG. 14 is an exploded perspective view of stack 106 of springs 152, 154 and 156 and a preload washer plate 142 as shown used in two locations in FIG. 13. Such stack in assembly comprises preloaded springs that are loaded with preload energy even before any fluid pressure acts on springs 152, 154 and 156, similar to how muscle tension works with an athlete. If fluid flow has to build up pressure to load such springs in response to a steering input, then there is a delay or lag and less precise response is achieved in control while directing movement of tie rods to turn vehicle wheels from a vehicle steering wheel and rack and pinion steering gear (or other steering gear).

As shown in exploded view in FIG. 14, springs 152, 154 and 156 each have a cylindrical outer periphery 162 and an inner periphery 160 that matches an inner diameter 164 of plate 142 sized to be received over shaft 38 in a stepped down region between shoulders 123 and 125 (see FIG. 13).

As shown in FIG. 14, preload washer plate 142 includes three spaced-apart arcuate raised ridges, or fingers 130. Optionally, some other plurality of fingers 130 can be used such as 2, 4, 5 or more. A lowered arcuate surface 132 is provided between each adjacent raised finger 130. A circumferential flat inner surface 166 is provided at a level lower than surfaces 132 to enable fluid to reach an underside of stack 106 when maximally flexed by plate 142. In assembly, spacer ring 145 compresses an inner periphery of stack 106 toward plate 142 which imparts a pre-compressed wavy configuration into the springs (such as spring 152) in stack 106. This wave preload flex pattern is different than a typical claim shell fold pattern normally induced in a stack of cylindrical shims, or springs.

FIG. 15 is a simplified schematic perspective view of an assembled together assembly of the stack 106 of washer springs 152, 154 and 156 (see FIG. 14) and preload washer plate 142 of FIG. 14 showing a preload bending of the stack 106 of springs 152, 154 and 156 in assembly while under a full fluid pressure load and flexed to a maximum extend while arcuate raised fingers 130 retain local outer peripheral portions of stack 106 while intermediate outer peripheral portions between adjacent fingers 130 are fully flexed into contact with lower portions 132 on plate 142 (see FIG. 14).

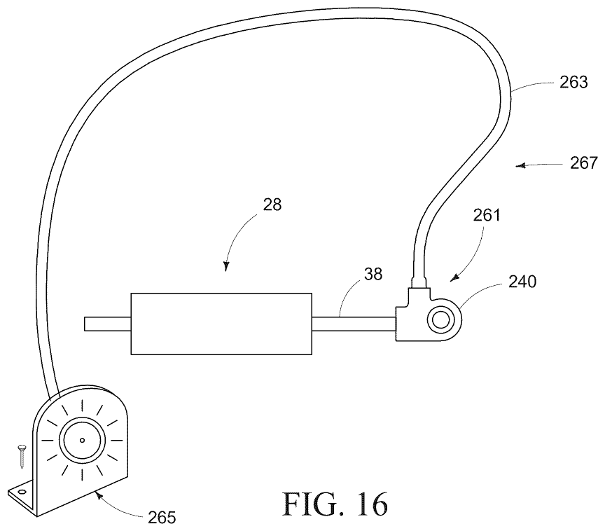

FIG. 16 is a remote damper/shock adjustment mechanism 267 usable on the dampened steering wheel system of FIGS. 1-3, 8-10 and 13 to remotely adjust dampening and shock characteristics. A remote actuator, or dial 265 is provided at a distal end of a sheathed cable 263. A remote control adjustment connector assembly 261 couples cable 263 onto a rotary controlled adjustment screw on eyelet 240 of shock/damper 28 at an end of piston rod 38. The adjustment screw adjusts fluid flow between opposed sides of an internal piston on shaft 38 to modify shock/damping characteristics from a remote location where actuator 265 is placed, such as inside of a vehicle cab.

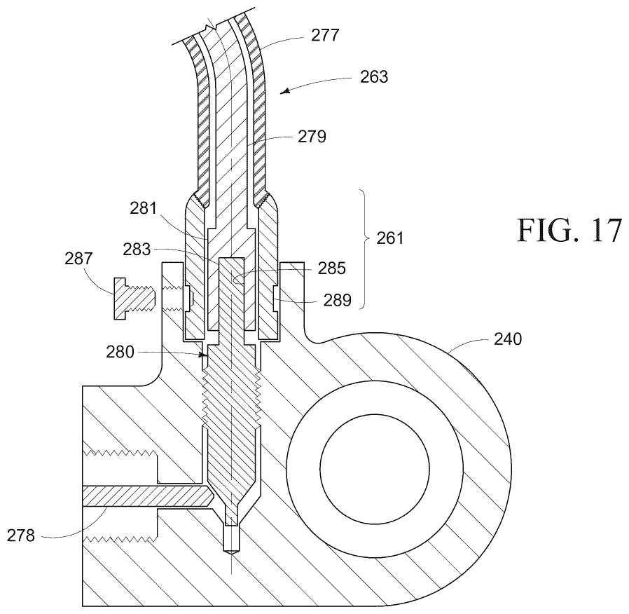

FIG. 17 is an enlarged centerline sectional view of remote control adjustment connector assembly 162 of FIG. 16 on damper rebound eyelet 240 and securing cable 263 onto eyelet 240. A cable sheath 277 expands at a proximal end to accommodate a female connector 281 at a proximal end of a rotating cable 279 in sheath 277. Proximal end of sheath 277 has a circumferential groove 289 that interlocks in assembly with a locking set screw 187 to retain sheath 277 onto eyelet 240. A square or rectangular tenon 283 interfits in complementary relation within a square or rectangular mortise 285 in the end of sheath 277 to interlock in torsion with a threaded adjustment screw 280 that coacts with a complementary tapered end of extension rod 278 (same as rod 178 in FIG. 13) to drive metering pin 176 (see FIG. 13) and adjust fluid flow through the secondary path.

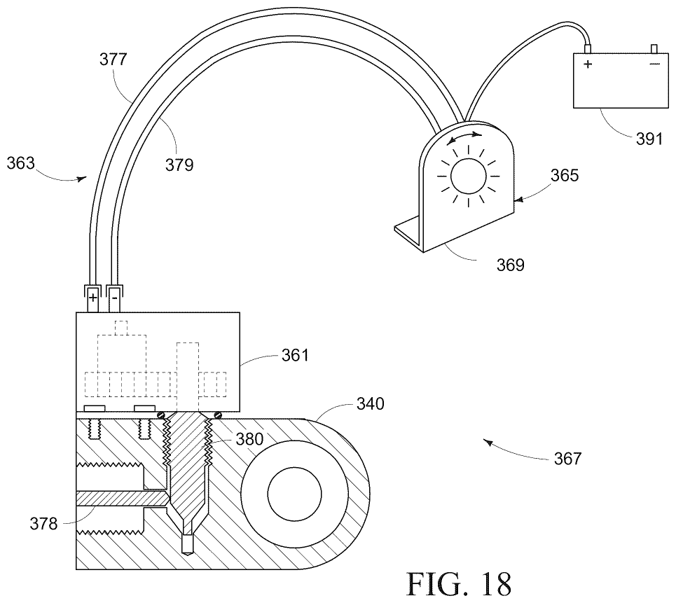

FIG. 18 is a simplified schematic diagram of an alternative electrical remote control adjustment mechanism 367 over that shown in FIGS. 16-17 but using an electrical control with an electrical wiring harness 363 having insulated conductive wires 377 and 279 for power and ground, a power supply, or battery 391 connected with a power line, a remote actuator, or rheostat 365 on a mounting bracket 369. An electrically actuated solenoid 361 drives a threaded adjustment screw 380 (similar to screw 280 in FIG. 17) in eyelet 340 to move extension rod 378 to adjust the flow rate along the secondary flow path of a shock/damper of FIG. 13.

It is understood that a remote shock/damper actuator can be any mechanical or electrical and/or electrical remote device including a wireless device using wireless communications signals. It is also understood that a preloaded spring can be any form of spring including coil, spiral, cylindrical, leaf, or conical spring.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

What is claimed is:

1. A steering damper assembly, comprising:
a chassis damper stay configured to mate at a first end with a first vehicle chassis frame member and at a second end with a second vehicle chassis frame member spaced apart from the first member;
a steering rack and pinion assembly intermediate the first end and the second end and carried by the chassis damper; and
a damper carried for movement at a first end by the steering rack on the rack and pinion assembly and acting against the chassis damper stay at a second end to dampen movement of the rack, the damper having a preloaded spring resisting extension and retraction of the damper.

2. The steering damper mount assembly of claim 1, wherein the damper comprises a piston cylinder, a piston, and a piston shaft extending from opposed ends of the piston cylinder.

3. The steering damper mount assembly of claim 2, wherein the piston includes unidirectional fluid flow ports extending between opposed sides of the piston in both directions and a preload spring sprung against an exit end of the fluid flow ports in each direction, the preload spring comprising a stack of springs carried is sprung relation against the preload washer platen urging the plate against the fluid ports.

4. The steering damper mount assembly of claim 3, wherein the preload spring comprises a stack of cylindrical springs.

5. The steering damper mount assembly of claim 4, further comprising a preload washer plate having a circumferential array of raised arcuate fingers configured in stacked engagement with the stack of cylindrical springs to bend the springs into a preloaded wave configuration.
